(19) United States
(12) Patent Application Publication
(10) Pub. No.: US 2011/0225565 A1
(43) Pub. Date: Sep. 15, 2011

(54) OPTIMAL INCREMENTAL WORKFLOW EXECUTION ALLOWING META-PROGRAMMING

(76) Inventors: Danny van Velzen, Redmond, WA (US); Jeffrey van Gogh, Redmond, WA (US); Henricus Johannes Maria Meijer, Mercer Island, WA (US)

(21) Appl. No.: 12/722,611

(22) Filed: Mar. 12, 2010

(51) Int. Cl. G06F 9/44; G06Q 10/00

(52) U.S. Cl. 717/114; 705/348

(57) ABSTRACT

A workflow is described and subsequently constructed by a general-purpose program. Among other things, such construction enables meta-programming to be employed. Further, workflow item and task dependencies can be explicitly expressed in the workflow and utilized to, among other things, optimize workflow execution for one or more factors. For instance, dependency information can be employed with respect to scheduling concurrent execution of tasks as well as to confine re-execution, upon workflow or item changes, to tasks affected by the changes. In addition, messages pertaining to workflow processing can be typed to facilitate logging in a structured and easily comprehensible manner.

### BACKGROUND

Workflow systems represent the application of technology to process management. A workflow is an organized set of interrelated tasks that define the operational aspect of a process or procedure. In particular, a workflow can define how tasks are structured, responsible entities, and relative ordering of tasks, among other things. Consequently, a workflow facilitates automated design, control, and monitoring of processes.

One widely known workflow is an enterprise workflow, which automates business processes such that documents, information, and/or tasks are passed to individuals for action in accordance with procedural rules. For instance, an individual can perform some designated work in a sequence, and subsequently, upon completion, work by others can be initiated. In effect, delivery of work is automated and controlled based on completion of precedent tasks. By way of example, a loan evaluation or approval process could be represented as a workflow.

Workflow can also be employed within the context of computer systems and functionality associate therewith, rather than solely human related tasks. By way of example, a specialized workflow system, known as a build system, can be employed to facilitate program development.

A build system enables a wide variety of program development tasks to be scripted and executed as a build including compilation of source code into binary code, testing, and deployment, among other things. While it is easy to invoke development operations from a command prompt for a single file, it is exponentially more difficult to similarly initiate such operations on a large number files with complex dependencies as is typically the case. A build system is designed to aid in this situation by enabling developers to describe and subsequently initiate execution of a series of calls to discrete units of code that each have a particular function multiple times. For instance, a build system can allow a program to be quickly re-compiled when a change is made to one or more component source files.

Workflows and builds in particular are currently specified utilizing a domain specific language or a markup language. A domain specific language (DSL) is a special-purpose language designed to work in a specific domain. For example, a graphical DSL is often employed that allows non-technical people to view and manipulate a process. A markup language, such as XML (eXtensible Markup Language), is a data description language for representing structured data by way of text annotations.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure generally concerns workflows including construction and execution thereof. A workflow can be described and constructed programmatically with a general-purpose programming language. Among other things, such construction allows meta-programming to be employed to observe, reason about, modify, and/or generate a workflow. Workflow task and item dependencies can be explicitly expressed by the workflow and utilized to, among other things, optimize workflow execution. For example, tasks can be segmented for concurrent execution across multiple processors and/or computers as a function of item and task dependencies. Additionally, upon occurrence of a change to a workflow or component thereof, dependencies can be utilized to confine re-execution to portions of the workflow that are affected by the change. Further, messages regarding workflow execution state can carry additional type information to allow the messages to be exposed in a structured manner to convey information efficiently to users. Also disclosed is functionality relating to undo operations and interoperability with conventional workflow systems.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a workflow system.

FIG. 2 is a graphical representation of workflow node instances and relationships.

FIG. 3 is a representative workflow object-graph that can be produced by a general-purpose program.

FIG. 4 is a block diagram of a representative schedule component.

FIG. 5 is a block diagram of a representative log component.

FIG. 6 is a screenshot of an exemplary user-interface that can be employed to log workflow messages.

FIG. 7 is a block diagram of a representative change-detection component.

FIG. 8 is a block diagram of a workflow system including test and setup components.

FIG. 9 is a flow chart diagram of a method of creating a workflow programmatically.

FIG. 10 is a flow chart diagram of a method of initial workflow execution.

FIG. 11 is a flow chart diagram of a method of re-executing a workflow after a change.

FIG. 12 is a flow chart diagram of a method of change detection.

FIG. 13 is a flow chart diagram of a method of performing an action with respect to a changed workflow.

FIG. 14 is a flow chart diagram of a method of workflow execution including scheduling tasks for execution.

FIG. 15 is a flow chart diagram of a task execution method.

FIG. 16 is a schematic block diagram illustrating a suitable operating environment for aspects of the subject disclosure.

### DETAILED DESCRIPTION

Details below are generally directed toward workflows including construction and execution thereof. A workflow can be constructed by a general-purpose program to take advantage of the expressiveness of general-purpose programming languages including specific language features or coding techniques such as, but not limited to, inheritance, parameterization, and, conditionals, as well as conventional tools associated therewith such as debuggers, type checkers, and code optimizers, among others. Furthermore, meta-programming can be performed, for example, to observe, reason about, modify, and/or generate workflows.

A programmatically constructed workflow comprising a set of interrelated nodes representing items and tasks can be executed incrementally from start to finish. Moreover, item and task dependencies can be explicitly expressed in the workflow and can be employed to, among other things, optimize workflow processing for one or more factors (e.g., time, cost . . . ). For example, tasks can be segmented as a function of item and task dependency to enable concurrent execution across multiple processors and/or computers. In addition, organized and meaningful messages regarding workflow execution state can be conveyed to a developer, for instance, by way of a graphical user interface (GUI).

After initial workflow execution, constraints between interdependent persistent items (e.g., documents, files, literals (e.g., name of an assembly) . . . ) can be maintained amongst subsequent changes thereto to ensure the workflow remains in consistent state. In accordance with one embodiment, whether or not an item has changed can be defined as coarsely or finely as desired and need not be time dependent. Once a change is detected, attention is turned to minimizing the amount of work needed to propagate the change and return to a consistent state. Workflow dependencies can again be employed to confine re-execution to a subset of the workflow affected by the change. Other disclosed features pertain to undoing actions and interoperability with conventional workflow systems, among other things.

Various aspects of the subject disclosure are now described in more detail with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

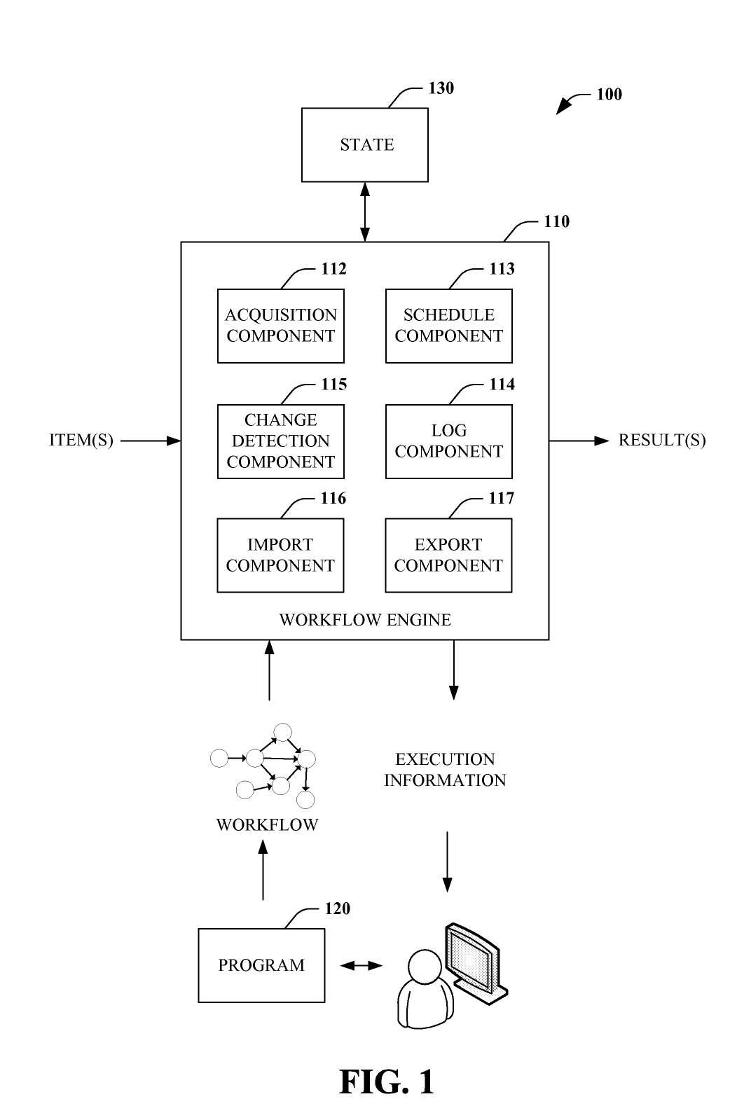

Referring initially to FIG. 1, a workflow system 100 is illustrated. The workflow system 100 includes a workflow engine 110 that generally functions to execute or process a workflow, wherein a workflow is a set of interrelated tasks and items that define a process or procedure. A task describes an action to be taken (e.g., copy, delete, invoke . . . ), and furthermore defines dependencies between itself, inputs, and outputs. Items can be task input and/or output (e.g., file, document, property . . . ). For instance, a task can consume as input one or more items and optionally produce as output one or more items. Alternatively, a task can produce as output one or more items without receiving one or more items as input. The workflow engine 110 acquires a workflow or representation thereof and any requisite items, executes the workflow, and optionally produces a result (e.g., set of one or more documents, files, executables . . . ).

The workflow system 100 can be employed in many different contexts including but not limited to business/enterprise processes and computer software development. For purposes of clarity and understanding, various aspects and embodiments of the disclosed subject matter will be described with respect to either business/enterprise processes or computer software development. Of course, the claimed subject matter is not intended to be limited thereby.

Note also that terminology can vary by context while the concept, feature, and/or functionality described remain the same. For example, the term “build” can be substituted for the word “workflow” herein when referring specifically to the software development context. As such, the workflow system 100 can be referred to as a build system 100, workflow engine 110 can be referred to as a build engine 110, and a workflow can be referred to as a build. Similarly, tasks, items, inputs, and outputs, among other things, can understandably vary by context without in anyway suggesting limitations on the scope of the claimed subject matter or applicable context.

In accordance with one embodiment, a workflow can be constructed programmatically from a workflow description (a.k.a. configuration file/script, description file, build file/script/configuration) specified in a general-purpose programming language (e.g., Java®, C#®, Visual Basic® . . . ), which is generally domain independent and Turing complete. In this manner, the workflow can take advantage of the expressiveness of general-purpose programming languages including particular language features or coding techniques such as but not limited to inheritance, parameterization, and conditionals, for example. In other words, a general-purpose language allows a wide variety of relationships to be easily described or defined including arbitrarily complex relationships. As well, by employing a general-purpose programming language workflows and developers thereof can take advantage of conventional tools associated with a particular language such as debuggers, type checkers, and code optimizers, among others. As depicted in FIG. 1, a developer can specify a general-purpose program 120 that describes a workflow and when executed constructs the workflow or a representation thereof (e.g., object graph).

Currently, the trend is to use a domain specific language (DSL) or extensible markup language (XML) to specify a workflow. However, DSLs and XML restrict the expressiveness or kind of computation that can used to describe a workflow, for example due to their declarative nature. Stated differently, DSLs and XML currently do not have the capability to express all computations that can be expressed by a general-purpose programming language (e.g., Java®, C#®, Visual Basic® . . . ). More formally, general-purpose program languages are referred to as Turing-complete meaning that they can express anything that a Turing machine can compute. By contrast, XML is not Turing-complete, and DSLs, while they could be Turing-complete, are conventionally designed with the explicit goal of not being Turing-complete. An analogous situation is the difference in expressive power between regular expressions and context free grammars, wherein less can be described by regular expressions than can be described by context free grammars. The same is true here with respect to DSLs and XML versus general-purpose programming languages. For example, if a DSL does not implement inheritance, function parameterization or conditionals there is no way to express certain things in that DSL. Accordingly, there are certain workflows that are unable to be described by DSLs and XML. Further yet, native support for inheritance, parameterization, and conditions, amongst other functionality provided by particular general-purpose program languages is well designed as a result of decades of evolution and generally performs much better than any extensions to a DSL or XML that can be made to emulate/simulate similar functionality.

As an example, consider a loan approval process including a plurality of related documents that need to be reviewed and signed by an applicant and evaluated by a lender. In conventional systems, a workflow would need to be generated for each specific lender since there can be differences in documents and the process itself from lender to lender. However, a better approach would be to produce a general loan approval process that can be parameterized for each specific lender. In other words, a workflow can be specified that can be instantiated with different parameters (e.g., loan documentation, terms and conditions . . . ). Furthermore, suppose the application process differs slightly for United States citizens and non-citizens. In this case, a conditional can be specified in the workflow. Still further yet, inheritance could be used to specify the distinction between types of applicants. Parameterization, conditionals, and inheritance are all natively supported by an object-oriented general-purpose programming language such as C#® or Visual Basic®. While an attempt to add similar functionality to a DSL or XML could be made, the result would be a poorly designed mini-language.

Furthermore, DSLs and XML do not have all the tools that are traditionally associated with general-purpose programming languages including type checkers, debuggers, and code optimizers, among others. By way of example, if a strongly typed general-purpose programming language is used to construct a workflow, the workflow can be type checked to reduce coding errors. For example, source code can be of type “Source” and assemblies can be of type “Assembly,” and if an assembly is attempted to be passed as a source file, a type checker can indicate that this is wrong, for example at compile time. Additionally, debuggers could be employed to test and debug a workflow, and code optimizers used to optimize specification of a workflow.

Still further yet, utilizing general-purpose programming languages to construct workflows enables meta-programming over a workflow, wherein meta-programming refers to the ability to observe, reason about, interact with, manipulate, and/or generate workflows as opposed to simply being able to execute a workflow. For example, suppose a workflow that represents the work a human pilot performs when on a flight. Further, suppose there are restrictions implemented that a pilot cannot work more than ten hours after which the pilot needs to be replaced by a new pilot. A program can be written that analyzes the workflow and determines whether the workflow can be finished within ten hours and decides whether two pilots are needed. Similarly, a workflow can be analyzed to determine whether it can be separated and run on multiple processors and/or machines. Additionally or alternatively, a workflow can be analyzed to determine whether execution can be optimized by swapping tasks or executing tasks in a different order.

Further yet, workflows can be input to other workflows, or in other words workflows can be self-applicable, such that a workflow can be produced that reasons about, changes, generates, and/or updates other workflows. As an example, suppose that if a developer produces code there is a requirement that the developer digitally sign the code. If a first workflow exists that does not sign code, a second workflow can be employed that transforms the first workflow such that it does sign code.

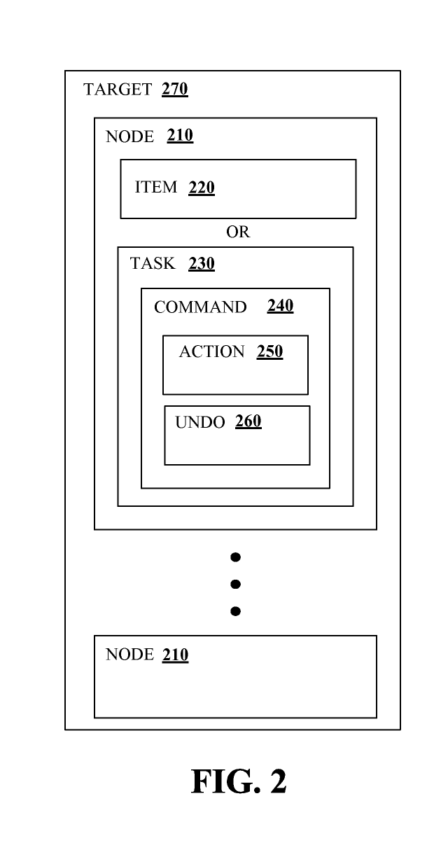

A general-purpose program can construct a graph of interrelated nodes. FIG. 2 provides a graphical representation of node instances and relationships to aid further discussion thereof. A node 210 can include a list of inputs and outputs as well as a unique identifier (ID) that is consistent and stable between different constructions of the graph. The unique identifier can rely on up-stream nodes in a graph (things it depends on) in order to allow partial execution for a workflow even when the workflow itself changes as will be described further infra. Each node 210 can be either an item 220 or a task 230.

An item 220 can describe information that a task needs to run. For instance, an item can be a file or a property (e.g., key/value pair used to configure a workflow) passed as metadata to the task. An item can be strongly typed, where supported, to reduce the chance of coding errors. By way of example, a property for a compiler can tell the compiler whether to produce a library or alternatively produce an executable (exe): “Property<TargetType>,” where “TargetType” is defined as “public enum TargetType{Library, Exe}.” Thus, when compiling the program that builds the graph, the compiler can enforce valid inputs to this property. The same holds true for files. For instance, a compiler can take an “Assembly” type, which derives from “File” as the type for the “Reference” argument, enforcing that only assemblies (e.g., executable (exe), dynamically linked library (dll) . . . ) are passed for this property. While an item 220 can be consumed by one or more tasks, the item 220 can also be produced by a task 230 upon execution.

A task 230 describes an action to be taken as well as a dual undo action for that action. A task 230 can have a set of input items 220 that direct or parameterize action. For example, a compilation task could have inputs such as a list of source files, assembly name, assembly reference, and target type, among other things. A task 230 can also have output items produced by an action. For instance, a compiler could produce an assembly as an output.

The action and undo action described by task 230 can be represented as commands 240 shown as action 250 and undo 260. By way of example, a shell execute command call to a compiler can be represented as an command action 250 with a set of arguments based on input items such as “csc.exe/nsystem.dll/t: library foo.csc/out:foo.dll,” where “csc.exe” calls the compiler, “system.dll” and “foo.csc” represent inputs, and “foo.dll” is the output. Although customizable, the default undo command 260 for tasks is to identify and remove output files. Accordingly, in the above example the undo command 260 would delete “foo.dll.” In one embodiment, the task 230 is also responsible for registering the dependencies between itself, inputs, and outputs.

A command 240 includes all information to execute an action. Once constructed a command 240 can be self-contained (although it can know the unique ID of the task that created it) and serializable to enable the command 240 to be transmitted to and executed by a different machine. In other words, a command can be represented as data, serialized, transmitted from a first computer to a second computer, de-serialized, and executed by the second computer. Further, a command can be self-contained and serializable to allow an undo command to be stored in a file and used to undo an action associated with a task that no longer exists as part of the workflow. A command 240 can also have an execute method that indicates success or failure of the command 240 as well a specific logger that automatically associates each logged message with a task that owns the command, as will be described further below. One example of a command is “ShellExecuteCommand,” which takes an executable to run or execute, a set of arguments, and an exit code (e.g., successful execution, failure) and upon execution will use operating system application programming interfaces (APIs) for executing an external command, providing messages to a logger, and return success or failure based on the exit code of the command.

Finally, a collection of nodes 210 can be referred to as a target 270. Such a target 270 can be passed to a workflow engine and employed to discover and execute work to be done.

The following is an exemplary general-purpose program that can be generated utilizing a general-purpose programming language such as C#® to describe and upon execution construct a workflow:

```
Assembly firstAssembly = new Csc(“First”,TargetType.Library)
  {
    Sources =
      {
          new SourceFile(@“c:\temp\first.cs”),
      }
  }.OutputAssembly;
Assembly secondAssembly = new Csc(“Second”, TargetType.WinExe)
  {
    Sources =
      {
      new SourceFile(@“c:\temp\second.cs”)
      },
    References =
      {
          firstAssembly,
      },
    Resources =
      {
          new ResGen (new
ResxFile(@“c:\temp\second.resx”)).OutputFile,
      }
  }.OutputAssembly;
CopyFiles layout = new CopyFiles(new [ ]
  {
    firstAssembly,
    secondAssembly
  }, @“d:\temp\result”);
Target target = new Target
  {
    Nodes =
      {
        layout
      }
};
```

Here, two assemblies are specified where the second references the first. Further, the second assembly links in a resource (e.g., string, image, persistent object . . . ) which is fed through a resource-file generator tool that converts a “resx” file format to a resource file. Further, “Csc,” “ResGen,” and “CopyFiles” are classes deriving from “Task,” and “Task.SourceFile,” “ResxFile,” “Assembly,” and “ResourceFile” are classes deriving from “Item.” More specifically, in this exemplary object-oriented language implementation requisite inputs can be passed to the constructor of the task while optional items can be registered by way of setting properties or method calls.

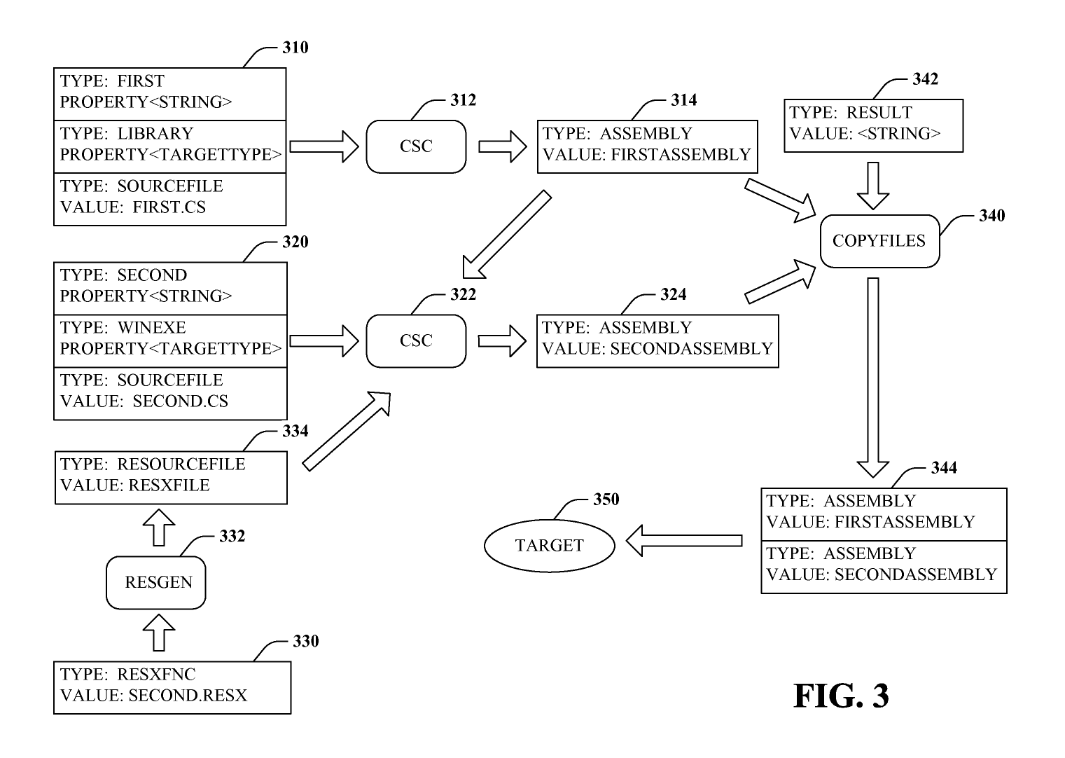

Executing the above code will create a graph in memory similar to that shown in FIG. 3. Here, source file item “FIRST.CS” 310 is provided as input to a compiler task “CSC” 312 to produce a first assembly 314. Source file item “SECOND.CS” 320 is provided to the compiler task “CSC” 322. Further, item “SECOND.RESX” 330 is provided to generator task “RESGEN” 332 to produce resource item “RESXFILE” 334, which is provided as input to the compiler task “CSC” 322. Also provided as input to the compiler task “CSC” 322 is item “FIRSTASSEMBLY” 314. The compiler task “CSC” 322 outputs an assembly item “SECONDASSEMBLY” 324. Items “FIRSTASSEMBLY” 314, “SECONDASSEMBLY” 324, and “RESULT” 342 are provided as input to task “COPYFILES” 340 that outputs item “LAYOUT” 344, which forms “TARGET” 350.

Returning to FIG. 1, the workflow engine 110 includes an acquisition component 112 that can receive, retrieve, or otherwise acquire the workflow constructed by program execution. For example, the acquisition component 112 can include an application-programming interface (API) that can be utilized to pass a graph of the workflow or the location of the graph, for example in memory or on some persistent store. Additionally, acquisition component 112 can perform some pre-processing operations with respect to the workflow to ensure it is in a proper form for processing. For example, if cycles are undesirable, the acquisition component 112 can execute known or novel algorithms to detect and report the presence of cycles. Further, validation operations can be performed on items of the workflow. For instance, if a document is supposed to have a signature therein, the document can be checked to ensure the signature is actually present as opposed to a blank image or other invalid input.

Once acquired and optionally validated by acquisition component 112, schedule component 113 can schedule execution or processing of the acquired workflow and more specifically schedule each task in the workflow for execution. Further, various factors can be considered by the schedule component 113 that govern when, where, and how tasks are scheduled for execution to optimize workflow execution for one or more factors, as will be described further below. For example, item and task dependencies captured by the workflow can be utilized as a basis to segment tasks into independent subsets for concurrent execution, for instance across multiple processors and/or machines. After execution, workflow state 130 can be saved to a persistent store such as a file for later reference. Subsequently, the workflow state 130 can be employed to aid determining whether a change has been made to the workflow and assist in targeted re-execution of at least a subset of the workflow.

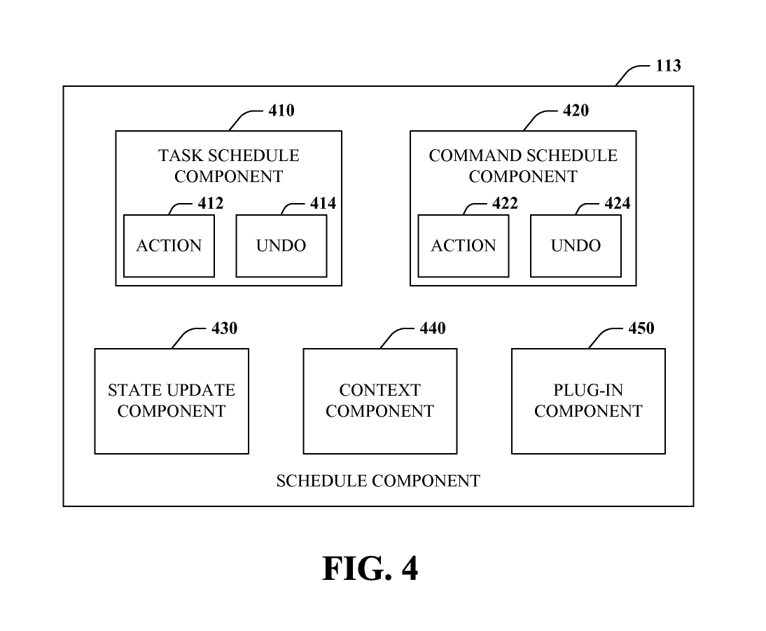

Turning attention to FIG. 4, a representative schedule component 113 is depicted in further detail. While tasks can simply be scheduled for execution in one step, in accordance with one embodiment, scheduling can be divided into two phases, namely task scheduling and command scheduling as represented by task component 410 and command component 420, respectively. Among other things, this provides a separation between the description of an action and execution of the action, which can aid in parallel and/or distributed processing as well as undo actions. As previously described, a task can describe an action that needs to be taken as well as the dual undo action. A command by contrast includes all the information needed to execute an action or undo action. By way of example, a data structure can first be created that represents an action or undo as data, and next the data structure that represents the action is executed thereby effectively executing the described action such that “F(a) =execute(new F(a)).” Accordingly, a task can be executed locally or passed to another computer for execution. Similarly, the undo action can be stored with workflow state such that it can be executed even if the corresponding task no longer forms part of the workflow. Thus, an action 412 or undo action 414 can be scheduled for execution by task schedule component 410 and subsequently the command schedule component 420 can schedule execution of a command that implements the described action 422 or undo action 424.

In operation, the task schedule component 410 can implement high-level scheduling operations when compared with command schedule component 420. For example, the task schedule component 410 can first locate tasks that have no inputs that are produced by the workflow and schedule those actions for execution by passing them to command component 420. When a task completes, the task schedule component 410 can check if any of the completed task's outputs are consumed by other tasks. For each of those tasks, a check can be made as to whether all inputs are available and if so that task is scheduled for execution by passing a description of the action to command schedule component 420. Further, the task schedule component 410 can schedule an undo action if upon a state check an associated task action is no longer part of the workflow. More specifically, the task schedule component 410 can de-serialize the undo command for that task from a persistent state store and pass it or otherwise make it available to command schedule component 420.

Once a task is scheduled for execution, the command schedule component 420 can schedule commands for execution on a local machine (e.g., across one or more processors or cores), multiple machines, in a cloud, or any other execution context. By default, the command schedule component 420 can schedule commands in a manner that fully utilizes resources of a particular execution context to minimize process time. For each task scheduled for execution, a variety of further checks can be made to ensure that all inputs are available, for example, and that a task can be executed. Amongst those checks, can be a determination of whether a task has changed and is subject to execution as will be described later herein. Once it is confirmed that a task will be executed, action and undo action commands 422 and 424 can be acquired from the task. The undo action command 424 can then be persisted to a state store, and the action command 422 scheduled for execution on a thread, for example. Furthermore, if an undo action or command is available from a previous run, the undo command action 424 can be scheduled for execution as well to reverse affects of a related action 424 previously executed.

State update component 430 is configured to ensure that task input and output states are saved to a persistent store (e.g., file, database, cloud . . . ) for use by subsequent runs of the workflow engine 110. If a store such as a state file does not exist, state update component 430 can create such a store. Upon execution completion of a task or command, state information concerning the inputs and outputs of the task can be stored. In one instance, the information can be time stamps identifying the last time the inputs where changed and the outputs where produced. However, the claimed subject matter is not limited thereto, as described in latter sections herein. In any event, information is stored that allows a determination of whether a state as changed across runs of the workflow. Still further, the state update component 430 can persist an undo command associated with an executed task to a store to allow actions to subsequently be undone even if the task no longer is part of the workflow.

Context component 440 provides contextual information to aid scheduling. In other words, based on the context or information provided by the context component 440, workflow execution can be scheduled in an optimal way. In one instance, context component 440 can acquire and provide information regarding execution context, such as the number of machines and/or processors or other available resources. The context component 440 can also acquire and provide information regarding the workflow itself such as size, depth and breadth, and dependencies, among other things, for example via meta-programming over the workflow. In one instance, such information can be employed to assign and execute tasks in accordance with execution priorities. In another example, workflow dependencies can be analyzed to determine whether it is possible to improve performance by breaking some dependencies and executing actions multiple times. Furthermore, it is to be appreciated that context information can be provided dynamically such that scheduling can be adjusted substantially in real time in response to dynamic context information. For example, scheduling can be altered based on load information associated with one or more processors and/or machines.

The schedule component 113 is pluggable such that scheduling can be governed by particular logic injected by way of a plug-in component 450. As such, the functionality of scheduling component 113 is not fixed but rather is extensible. By way of example, scheduling can be extended to optimize for something other than time such as energy cost. Utilizing plug-in component 450 the schedule component 113 can be altered to schedule tasks for execution when energy is cheaper, for instance at night. The context component 440 can also be altered by the plug-in component 450 to acquire and receive energy cost information such that scheduling can be adjusted dynamically, for example. Additionally or alternatively, scheduling can be modified to move away from using machines with large fixed drives to minimize energy use.

Returning briefly to FIG. 1, the workflow engine 110 also includes log component 114 configured to observe and expose execution information in the form of messages or notifications provided to a developer, for example. Furthermore, data types can be associated with the messages to provide additional information regarding messages and a means for message classification. By way of example and not limitation, the log component 114 can expose three types of messages with various subtypes, namely general workflow messages (e.g., start, succeeded, failed . . . ), task status messages (e.g., task queued, task started, task change state, task failed, task succeeded . . . ), and/or command execution messages (e.g., information, warning, error . . . ). Further, these message types can carry different kinds of details. For instance, general workflow messages can include a graph of the workflow, task messages can include the task to which they apply, and command execution notification can include the task it belongs to as well as optional source location.

Among other things, message typing allows complex logging to be exposed in a structured way that is easy to understand. By way of example, in a simple context where a workflow is executed on a single processor computer, a log component 114 can produce things as they are sequentially executed such as “Task A,” “Task B,” and “Task C.” However, when at least a subset of tasks are parallelized or distributed, the same log component 114 would interleave messages from the tasks. By linking specific types to messages, the messages can easily be filtered by the log component 114. For instance, the log component 114 can provide messages associated with a specific task or a task with the most warnings can be identified. Such structured information can be especially helpfully with respect to workflow debugging.

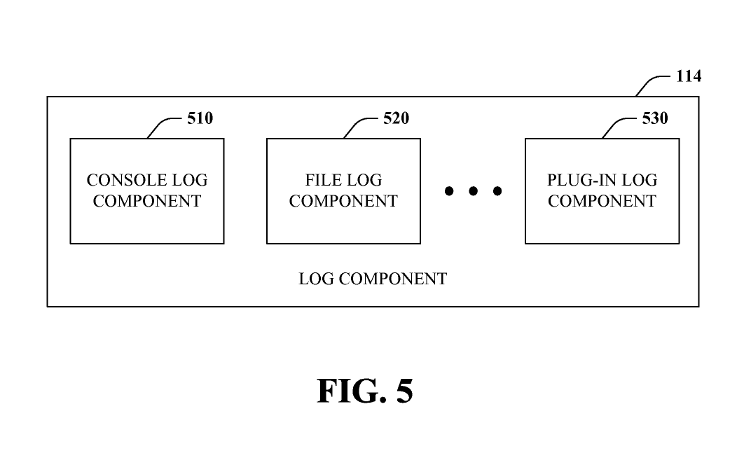

Referring to FIG. 5 a representative log component 114 is depicted. As shown, the log component 114 can include various specific loggers, or alternatively the log component 114 can be embodied in different forms. For example, the log component 114 includes console log component 510 that exposes notifications by way of a command line interface. Additionally or alternatively, a file log component 520 can be employed that saves notifications to a file or other persistent data structure. The log component 114 is also pluggable. In other words, additional components such as plug-in component 530 can be added to extend, modify or replace existing or default log functionality. In one example, the plug-in component 530 can provide a rich graphical user interface to display workflow messages in a manner that is easy to comprehend as opposed to a simple list of messages.

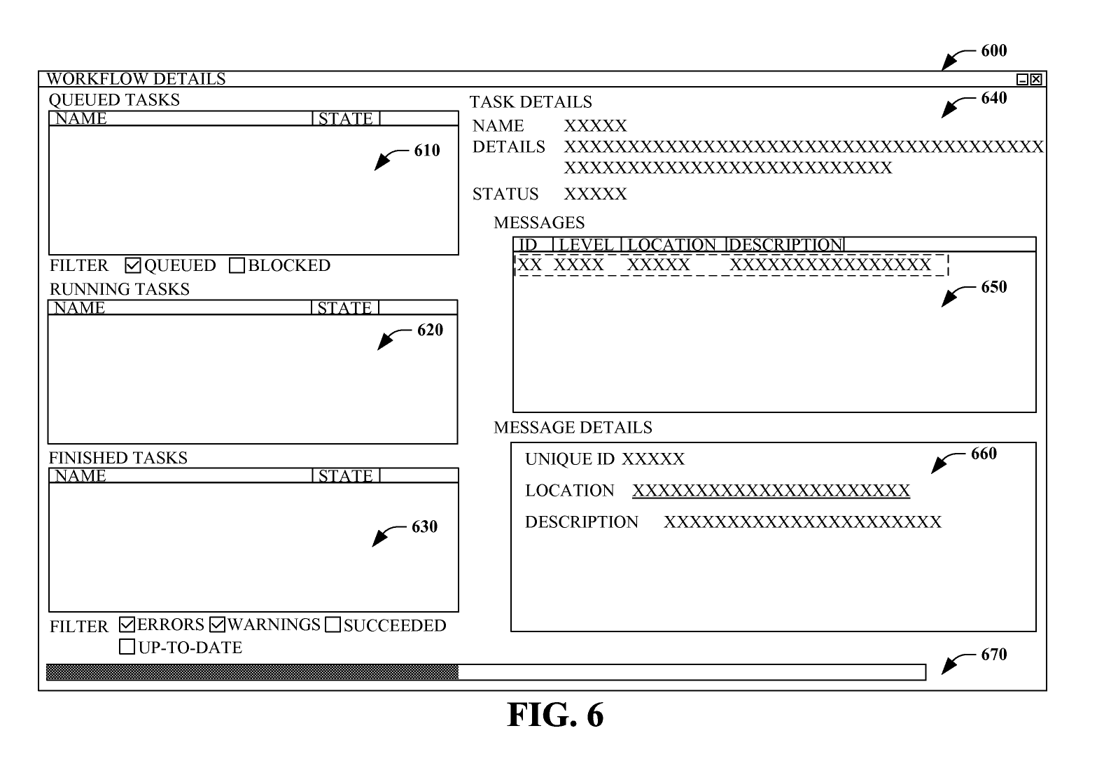

FIG. 6 illustrates a screenshot of an exemplary graphical user interface (GUI) 600 that can be employed with workflow engine 110 and more specifically log component 114. The GUI 600 includes a plurality of graphical elements to aid presentation of information including a number of windows or panes as well as text, among other things. Window 610 provides a list of all tasks that have not yet been processed, for example because the tasks have dependencies that are blocking the tasks or there are no resources available to execute the task. Window 620 lists the tasks whose commands are currently running, for example on one of the engine's threads. Window 630 identifies tasks that have finished. Further, these finished tasks can be filtered to show errors, warnings, succeeded, and/or change status. Textual details about a task selected from windows 610, 620, or 630 are displayed at 640. Window 650 shows messages associated with a selected task details of which can be provided at 660. Additionally, if a source location is present then clicking on the location will launch an editor to inspect the source location. Finally, progress bar 670 visually depicts the progress of a workflow process. Although not shown here, in one embodiment, different colors can be employed to provide additional information. For example, light green indicates no changes, dark green means succeeded, blue corresponds to in progress, gray represents queued tasks, red corresponds to an error, and orange indicating a warning.

Referring back to FIG. 1, after a workflow is initially executed or processed, the workflow may need to be re-run. For example, if changes are made to one or more items, those changes can be propagated through a workflow in order to maintain a valid or consistent state. In a code-building context, for example, if a source file is substantially reworked (e.g., methods added and/or deleted), the workflow can be re-executed so that those changes are reflected in any output results, such as an assembly. Change detection component 115 is configured to identify changes.

Conventional workflow systems rely on timestamps to determine whether an item (e.g., file, document . . . ) is up to date. More specifically, an input item timestamp is compared to a timestamp associated with workflow output, and if they are the same the item is deemed up to date; otherwise, the item has changed. There are several issues with this approach. First, if a workflow does not produce output, the item is deemed to have changed. Second, other programs such as virus scanners can touch files and alter timestamps, which cause the items to be considered out of date. Further, in a distributed computing context machine clocks can be slightly different causing items to be mistakenly deemed to have changed or not have changed.

While the change detection component 115 can utilize a conventional timestamp mechanism to determine change, in accordance with one embodiment, the definition of whether an item has changed can be as fine grained or as coarse as desired. For example, a finer grain approach to conventional timestamps would be to compare timestamps of items consumed and produced by a task. Moreover, determining whether or not something has changed need not be based on timestamps at all and in fact can be time independent.

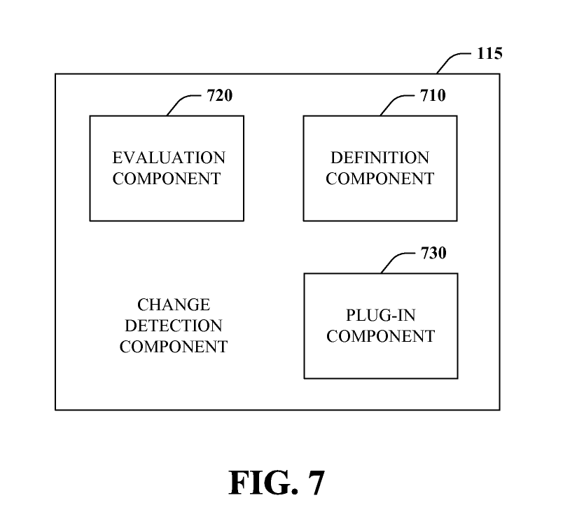

Turning to FIG. 7, a representative change-detection component 115 is depicted in further detail. As shown, the change detection component 115 includes a definition component 710 and an evaluation component 720. The definition component 710 can define what change means for a particular item. The evaluation component 720 evaluates an item with respect to a specific definition and potentially some persisted state information. Further, a change definition can be defined for an item with respect to a particular task. Still further, the change detection component 115 is pluggable. In other words, the notion of what a change means as defined and implemented by definition component 710 and evaluation component 720 can be modified, updated, or replaced by logic provided by plug-in component 730.

As an example of change detection, consider a situation in which a file title is changed. Conventionally, the file would be deemed to have changed since the timestamp associated with the item would have changed. However, the definition of change for the file in this case might exclude a change to the title. Accordingly, when evaluated by the evaluation component 720, the file would not be deemed to have changed and thus the workflow would not be re-run.

In another example, the evaluation component 720, in accordance with a change definition, can compare a current version of the file with a previously stored version or a portion thereof to determine whether the file has changed. Similarly, a function such as a hash function can be applied to a file upon initial workflow execution the value of which can be stored as state information. Subsequently, the definition component 710 can indicate that the hash function is to be applied to the current version of the file and the resulting value or values are to be compared to those values stored as state.

Returning to FIG. 1, upon detection of a change by change-detection component 115, changes can be propagated by notifying the schedule component 113 that one or more particular items have changed and that the workflow needs to be re-run. Unlike conventional systems, however, workflow engine 110 need not re-run the entire workflow after any change. Rather, dependencies amongst tasks and items can be analyzed and re-execution confined to a subset of the workflow affected by one or more changes. For example, if task “A” depends on task “B” and task “C depends on tasks “D” and “E,” then a change to task “B” will result in re-execution of task “A” but not tasks “C,” “D,” and “E, since tasks “A” and “B” and tasks “C,” “D,” and “E” are independent subsets. In other words, whenever a change occurs, only the minimal amount of work needed to bring the workflow back into a consistent state is performed.

Furthermore, during workflow processing the workflow engine 110 via the scheduling component 113, for instance, can also avoid hidden dependences by employing anonymous locations with respect to intermediate items. As an example, suppose task “A” is followed by task “B,” and upon execution task “A” places a file at a specific location. Task “B” is encoded to retrieve the file from the specific location and performs some action. Here, the specific location is a hidden dependency where it is a convention to place the file at the specific location but the specific location is not explicitly encoded in the workflow. This is problematic at least because the workflow engine 110 does not know and cannot reason about the dependency. Rather, knowledge of the dependency is confined to workflow developers. As a result, the workflow engine 110 cannot determine if tasks can be distributed or run parallel and whether or not one task can be run before another task. To address hidden dependencies, the workflow engine 110 can store intermediate files or the like to anonymous locations, which are locations that are unknown prior to workflow execution. In this manner, there is no way for a developer to know where intermediate files will be stored and create hidden dependencies. Consequently, by utilizing anonymous locations developers are forced to express dependencies explicitly in the workflow. Stated differently, the workflow engine 110 may not take into account dependencies that are not expressed in a workflow.

With reference to dependencies, both task and item dependencies can be expressed explicitly in a workflow. Conventional systems do not offer true dependency tracking. More specifically, often only task dependencies are expressed while item dependencies are disregarded completely. As a result, workflow system performance suffers since opportunities for concurrent execution are limited if at all possible. For example, even if the workflow engine knows tasks are to be executed in a particular sequential order concurrent task execution cannot be utilized because tasks can depend on the same item or produce items that are used by another task. The problem is further complicated if dependencies are hidden rather than expressed in the workflow. However, by capturing all task and item dependencies explicitly in a workflow, the workflow can be segmented into independent subsets of the workflow that can be utilized to support at least concurrent execution and select re-execution of the workflow.

As a result of captured item and task dependencies and the ability to schedule for execution a portion of the workflow as described supra, note that one or more nodes can be selected for re-execution. For example, a visualization of the graph can be provided to a developer via a graphical user interface from which nodes can be selected. This can be advantageous when working with large groups of products. Consider a suite of office software including a word processor, spreadsheet, and presentation components. If a developer is only concerned with the word processor component, they can designate that portion of a build to be re-executed after a change is made. Stated differently, a larger graph can be split up into sub-graphs and provided for execution, for example using meta-programming.

The workflow engine 110 also includes import component 116 and export component 117 to facilitate interaction with respect to existing conventional workflow systems. The workflow engine 110 can operate over a dependency graph created by a general-purpose program. Conventional domain specific language and XML workflows can be converted or encapsulated by the import component 116 to allow interoperability. In one implementation, the import component 116 can include a parser and re-writer to parse an existing workflow and rewrite the workflow as a general-purpose program that when executed creates a dependency graph. Alternatively, an existing workflow can be encapsulated as a task in the disclosed system. The opposite of importing is exporting a dependency graph and/or other workflow representation produced from a general-purpose language description to a domain specific language, XML or other representations. Export component 117 can perform this functionality to convert the disclosed workflow by rewriting it in any target representation.

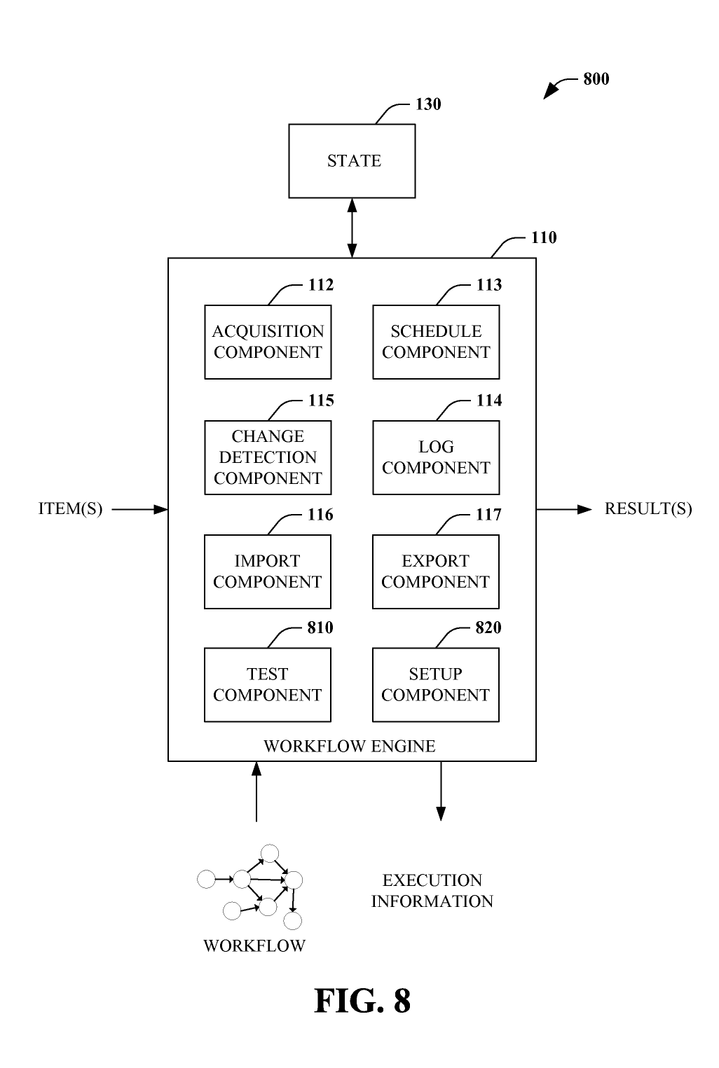

Workflow systems can do more than process a workflow. As shown in workflow system 800 of FIG. 8, the workflow engine 110 can also include a test component 810 and a setup component 820 with respect to program creation workflows, for example. The test component 810 is configured to perform one or more tests on workflow code and/or results produced by the workflow. Moreover, the test component 810 can exploit workflow dependences to execute over only a portion of workflow code and/or results produced thereby where possible. Conventionally, developers build all code and then run numerous tests, which can be a complicated process. Further, a build (e.g., variety of tasks that are performed to build or produce a program (e.g., calling a compiler, linking code, copying files to a directory . . . )) can take up to an hour and tests can take multiple days to complete. If a change is made, conventionally code is rebuilt (e.g., different version) and test execution is initiated from the beginning. However, test component 810 can use information about the change and dependencies and execute a subset of all tests, wherein the subset targets solely the change and code affected thereby (e.g., 500 tests rather than 100,000 tests). Accordingly, test component 810 can decrease the cost of making a fix to a software product.

The setup component 820 is configured to generate a build setup to facilitate software installation. Conventionally build systems are typically designed to take source code as input and produce a binary as output. However, it is often desirable to create an executable that can be utilized to install built software on a computer. Currently, developers generate the setup workflow separately. Setup component 820 can leverage meta-programming, in one instance, to generate a setup workflow automatically by analyzing input(s) and output(s) of a build. Further, where a build is changed, the setup component 820 can leverage workflow or more specifically build dependencies to create setup portions that are affected by the changes. Similar to the test component 810, the setup component 820 again reduces the cost of fixing software.

The aforementioned systems, architectures, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, as will be appreciated, various portions of the disclosed systems above and methods below can include or consist of artificial intelligence, machine learning, or knowledge or rule-based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent.

By way of example and not limitation, change detection component 115 and the schedule component 113 can employ such mechanisms. For instance, rather than requesting a definition of change for an item, meta-programming can be employed to reason about a workflow and infer when an item has changed. Similarly, the schedule component 113 can employ contextual information to infer when to schedule task and/or command execution to optimize for time or other factors.

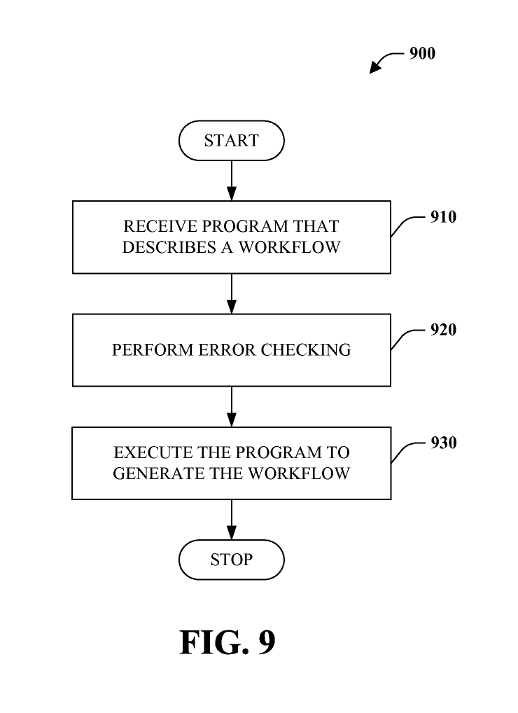

In view of the exemplary systems described supra, methodologies that may be implemented in accordance with the disclosed subject matter will be better appreciated with reference to the flow charts of FIGS. 9-15. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

Referring to FIG. 9, a method 900 of creating a workflow programmatically is depicted in accordance with one embodiment. At reference numeral 910, a program is received that describes a workflow in a general-purpose programming language (e.g., Java®, C#®, Visual Basic® . . . ). At numeral, 920, the received program is checked for coding errors. By way of example, where the program is strongly typed, type checking can be performed, for instance, during program compilation. Furthermore, other tools associated with the general-purpose programming language can be applied to the workflow including a debugger and/or code optimizer, among others. At reference numeral 930, the program is executed to generate a workflow. For instance, the workflow can be represented as a dependency graph of interrelated nodes representing workflow items and tasks, wherein both item and task dependencies are explicitly expressed in the workflow. In sum, a workflow can be created programmatically as opposed to being declared directly. By analogy, this technique is similar to the difference between a car and a factory that makes the car. Furthermore, workflows can be created much faster, and complex workflows are easier to produce than those that are directly declared, for example utilizing a domain specific language or a markup language.

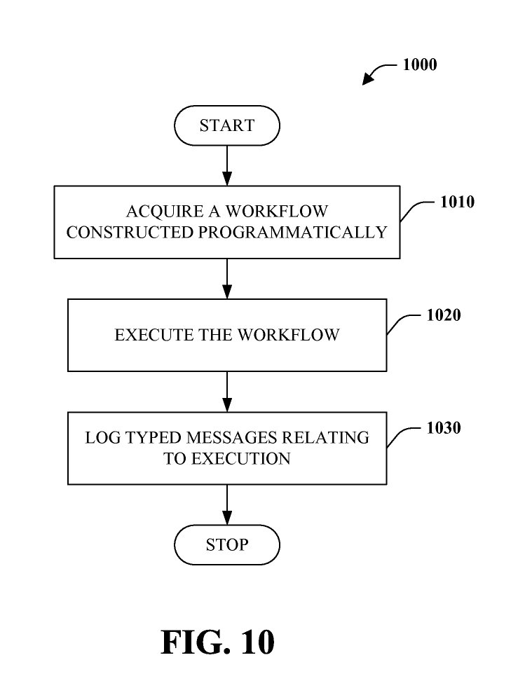

FIG. 10 illustrates a method of initial workflow processing 1000. At reference numeral 1010, a programmatically constructed workflow is acquired. For example, a graph of a workflow including a plurality of items and tasks can be acquired from memory after execution of a general-purpose program that describes the workflow. At numeral 1020, the workflow is executed from start to finish. For instance, a workflow that describes a code build can produce a binary file as a result of a series of build tasks including compilation of source files in a specific order. Furthermore, the workflow can be segmented into independent subsets as a function of item and task dependencies expressed in the workflow and concurrent execution of two or more of the independent subsets can be initiated. At reference 1030, one or more typed messages are logged (e.g., via console, file, user interface . . . ) concerning execution of the workflow. Message types can include but are not limited to general execution state (e.g., start, succeed, fail . . . ), task status (queued, started, failed succeeded . . . ), and command execution information (e.g., warning, error . . . ), wherein each message type can carry various detailed information such as a workflow graph, task identification, and source location. Among other things, additional information provided by a message type enables messages to be exposed in an organized manner, for example to aid comprehension or in other words efficiently convey information to a user.

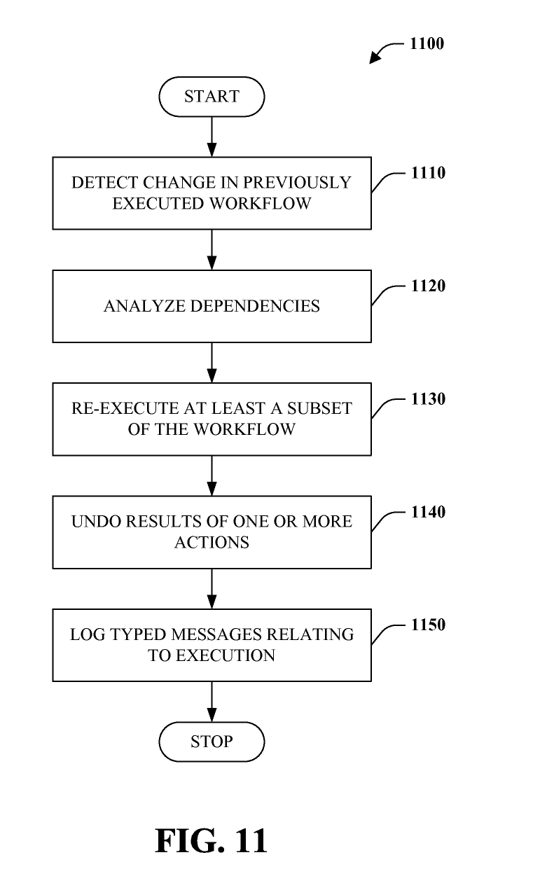

FIG. 11 depicts a method 1100 of re-executing a workflow after a change. At reference numeral 1110, a change is detected either to a part of the workflow, such as an item, or the workflow itself. At numeral 1120, workflow dependencies are analyzed to identify items and/or tasks affected by the detected change. At least a subset of the workflow is re-executed based on the change and dependencies at reference 1130. In other words, unless a change affects the entire workflow, a select portion of the workflow is scheduled for re-execution. At reference 1140, results of one or more actions can be undone, for example, where a task that was previously part of the workflow is removed. Although not limited thereto, in one instance, an undo action can reverse a previous task action by deleting the result of the action. At numeral 1140, typed messages relating to workflow re-execution can be logged to a console, file, or user interface to expose internal actions and/or state. Furthermore, the messages can be organized in an easy-to-understand manner utilizing information associated with a type of the message.

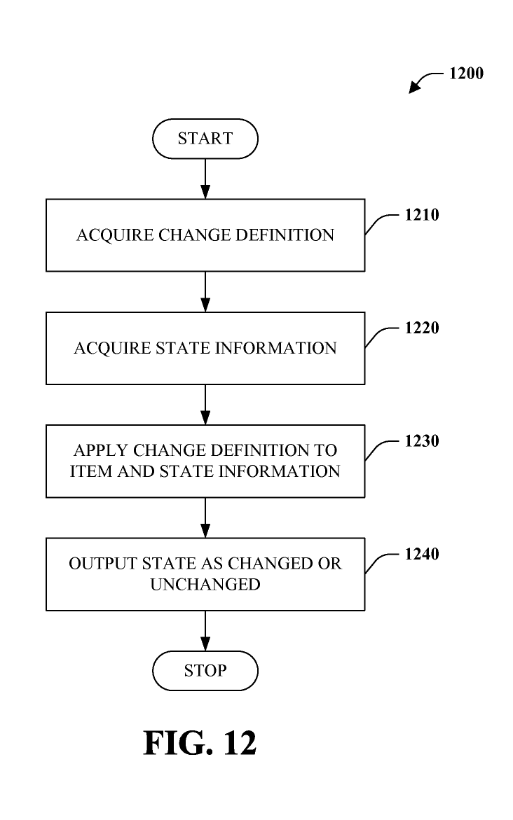

FIG. 12 is a flow chart diagram of method of detecting a change 1200 in accordance with one embodiment. At reference numeral 1210, a change definition is acquired, wherein the change definition defines what a change means with respect to particular workflow items (e.g., file, document, assembly . . . ). In accordance with one embodiment, a developer can specify the change definition. Alternatively, a default definition can exist for particular item types or the definition can be inferred from other definitions or a safe notion of change, among other things. At numeral 1220, information about the prior state of an item is acquired, for example from a state file. The change definition is applied to the prior state and current state of an item to determine whether the item has or has not changed at numeral 1230. For example, if the change definition requires strict identity, the prior state and the current state are compared, and if there is any difference, the item will be deemed to have changed. At reference 1240, the determination of whether or not an item changed is output. Whether or not a task has changed can be determined based on whether or not at least one input or output item of a task has changed as described above.

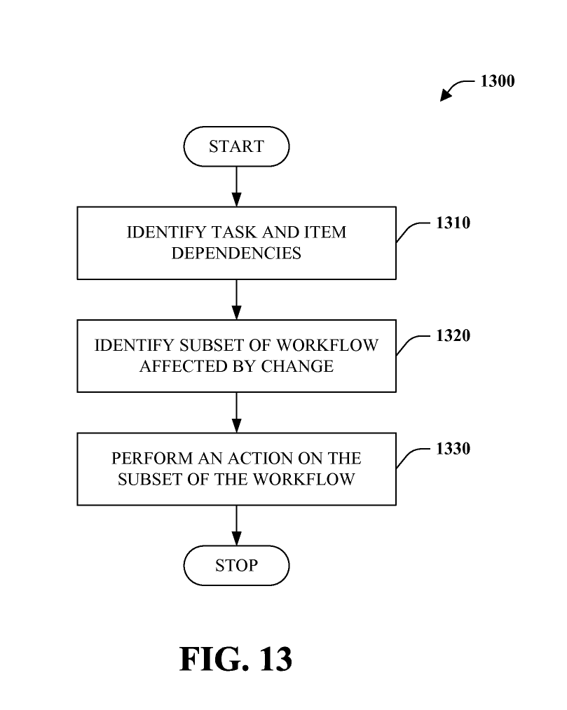

FIG. 13 is a flow chart diagram of a method 1300 of performing an action over a changed workflow. At reference numeral 1310, dependencies are identified between workflow tasks and items of a changed workflow. A subset of the workflow is identified as a function of the change as well as items and tasks that are affected by the change at 1320. At reference numeral 1330, an action is performed over the subset of the workflow identified. Such actions can include those associated with workflow processing as well as others. By way of example and not limitation, such actions can correspond to testing or generation of a setup or installation process in code context where the workflow corresponds to a build process. In this manner, the cost of running tests and building a setup can be reduced upon occurrence of a change in the workflow since only those actions affected by the change can be performed.

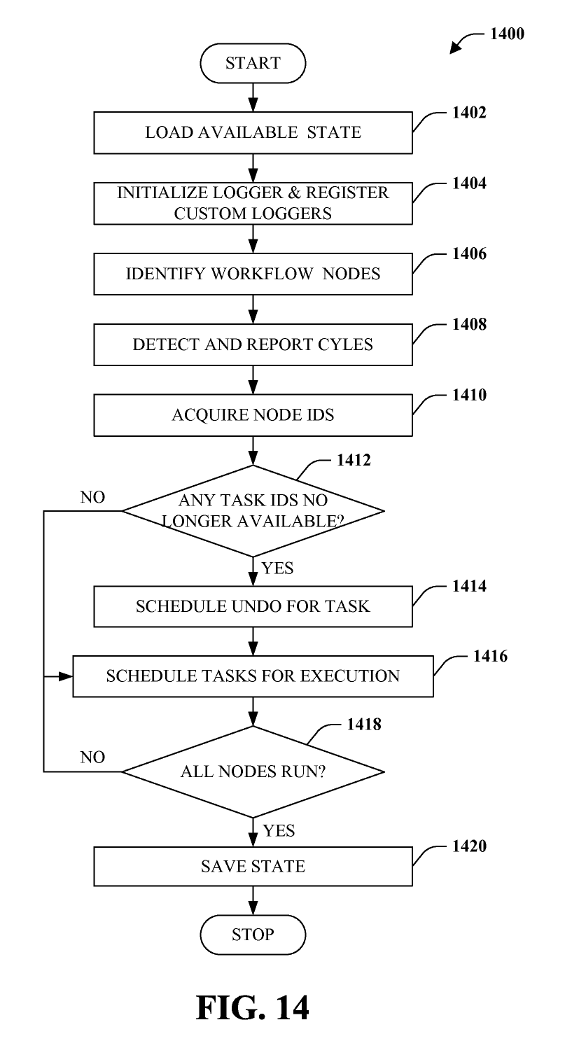

FIG. 14 depicts a method 1400 of workflow execution including task scheduling in accordance with one embodiment. At reference numeral 1402, any available state information associated with a workflow is loaded, for example from a state file. Such information can describe, among other things, the state of component items of a previously processed workflow. At numeral 1404, workflow loggers are initialized and custom loggers are registered with the workflow engine to enable workflow processing information to be exposed including identification of queued, running, and/or finished tasks as well as any errors or warnings associated with the tasks. Workflow nodes are identified at reference 1406, for example from a workflow dependency graph constructed programmatically. In one implementation, information associated with a target node can be utilized in conjunction with conventional graph algorithms to identify item and task nodes in a graph. A workflow engine may desire to avoid cyclic workflow graphs. In this case, at 1408, known or novel graph algorithms can be utilized to perform cycle detection and report identified cycles including, for instance, a full description of the cycle.

At reference numeral 1410 unique and stable identifiers (IDs) are acquired for each node. A determination is made at reference 1412 as to whether or not any node IDs are not available that were previously available by referencing the loaded state information. Such a situation can occur when a task that previously formed part of the workflow was later removed. If, at 1412, it is determined that a unique node identifier existed with respect to a previous state of the workflow and no longer forms part of the workflow (“YES”), an associated undo action is scheduled at 1414. Otherwise, the method continues at 1416. In one instance, an undo command stored in a state file can be de-serialized and scheduled for execution. This enables results of a task to be undone or reversed even though the task no longer forms part of the workflow.

Tasks are scheduled for execution at numeral 1416. This can include identifying tasks that have no inputs that are produced by subsequent task execution utilizing standard graph algorithms, and scheduling those tasks for execution first. When a task completes, a check can be made as to whether any of its outputs are consumed by other tasks, and for each of those tasks, if all inputs are available, they are scheduled for execution. At reference numeral 1418, a check is made as to whether all nodes were processed. If all nodes have not been processed (“NO”), the method continues at 1416 to schedule task execution. If all nodes in the workflow have been run (“YES”), the state of all items is saved at 1420 and the method terminates.

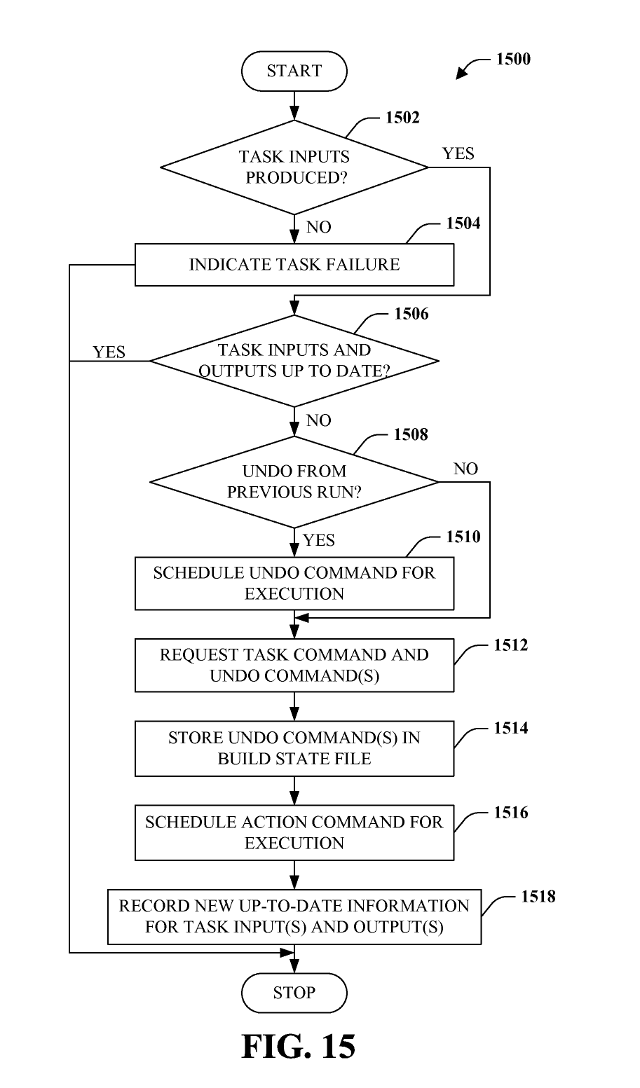

FIG. 15 is a flow chart diagram of a method 1500 of task execution in accordance with on embodiment. After a task is scheduled for execution for example as provided in method 1400 of FIG. 14, the following actions can be performed. At reference numeral 1502, a determination is made as to whether or not inputs to a scheduled task have been produced. If one or more of the inputs is not available (“NO”) (e.g., a task was supposed to produce them but failed), task execution failure is indicated at 1504 and the method terminates. Otherwise, if all inputs are available (“YES”), the method continues at 1505. Here, another check is made as to whether or not all inputs and outputs of the task are up to date, or in other words, they have not changed since prior task execution, if it was previously executed. If all inputs and outputs are determined to be up to date (“YES”), then the task is up to date and the method terminates. If the task is not up to date or, in other words, the task has changed (“NO”), the method proceeds to 1508 where a determination is made concerning whether an undo command has been scheduled. In one instance, this can be ascertained by checking a state file for an undo command. If an undo command exists (“YES”), the method continues at 1510 where the undo command is scheduled for execution, for example on one of the workflow engine's worker threads. If an undo command does not exist (“NO”), the method skips act 1510 and proceeds to reference numeral 1512 where action and undo commands are acquired from the task. Next, at 1514, the undo command for the task is saved to the state file. The action command is then scheduled for execution at reference 1516. Finally, upon completion of action command execution, new state is saved to the state file at 1518 regarding a task's inputs and outputs.

As used herein, the terms “component,” “system, and “engine” as well as forms thereof are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner It is to be appreciated that a myriad of additional or alternate examples of varying scope could have been presented, but have been omitted for purposes of brevity.

The term “cloud” is intended to refer to a communication network such as the Internet and underlying network infrastructure. Cloud computing generally pertains to Internet or cloud based applications or services including without limitation software as a service (SaaS), utility computing, web services, platform as a service (PaaS), and service commerce. Although not limited thereto, typically cloud services are available to clients via a web browser and network connection while the services are hosted on one or more Internet accessible servers.

“Persistent data” or the like is intended to refer to data stored on a non-volatile medium that exists across application sessions. In other words, the persistent data survives application startup and termination. By contrast, “transient data,” often saved on a volatile medium such as memory, is created within or during an application session and is discarded at the end of the session. Similarly, the term “persist,” or various forms thereof (e.g., persists, persisting, persisted . . . ), is intended to refer to storing data in a persistent form or as persistent data.

A “workflow” is a set of interrelated tasks that define the operational aspect of a process or procedure and can consume and/or produce one or more items (e.g., files, documents, executables, literals . . . ). As described herein, a workflow can be described and generated by a program as well as observed, reasoned about, and or modified programmatically. Furthermore, a build system can be one instance of a workflow wherein tasks are performed to generate or build a program. However, as used herein the term “workflow” is not intended refer to a program per se wherein actions are performed with respect to various pieces of data.

“Concurrent execution” or the like refers to processing at least a portion of tasks, workflows, commands, or computer instructions simultaneously rather than sequentially. One form of concurrent execution includes parallel processing wherein processing occurs across two or more processors or cores on a single computer. Another form of concurrent execution includes distributed processing wherein processing occurs across two or more computers. Further, concurrent execution can encompass both parallel processing and distributed processing such that processing occurs across a plurality of computers and processors or cores.

As used herein, the term “inference” or “infer” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

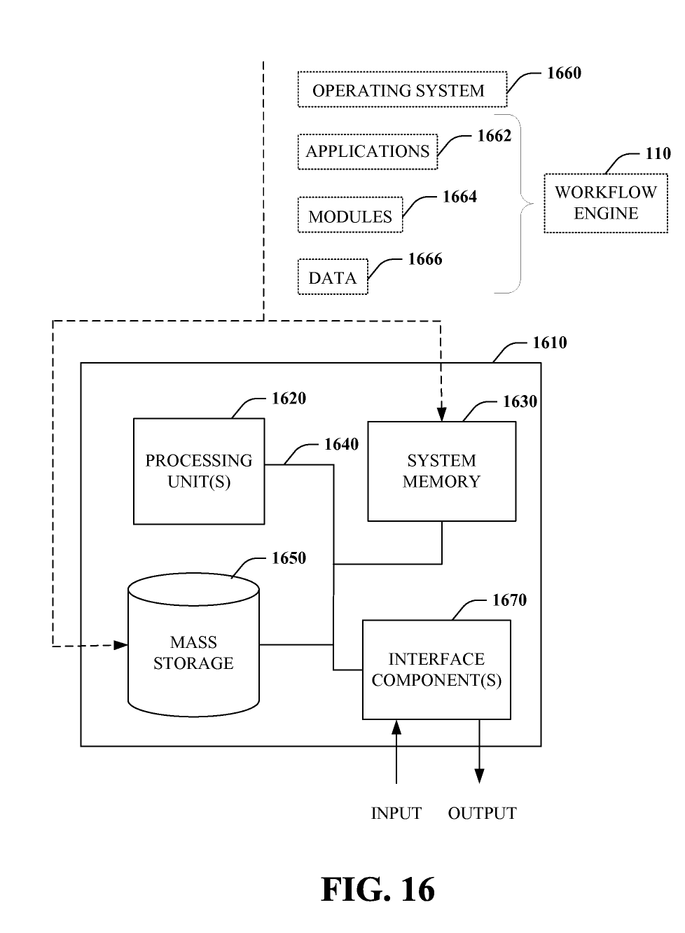

In order to provide a context for the claimed subject matter, FIG. 16 as well as the following discussion are intended to provide a brief, general description of a suitable environment in which various aspects of the subject matter can be implemented. The suitable environment, however, is only an example and is not intended to suggest any limitation as to scope of use or functionality.

While the above disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. Aspects can also be practiced in distributed computing environments where tasks are performed by remote processing devices that are linked through a communications network. However, some, if not all aspects of the claimed subject matter can be practiced on stand-alone computers. In a distributed computing environment, program modules may be located in one or both of local and remote memory storage devices.

With reference to FIG. 16, illustrated is an example computer or computing device 1610 (e.g., desktop, laptop, server, hand-held, programmable consumer or industrial electronics, set-top box, game system . . . ). The computer 1610 includes one or more processing units or processors 1620, system memory 1630, system bus 1640, mass storage 1650, and one or more interface components 1660. The system bus 1640 communicatively couples at least the above system components. However, it is to be appreciated that in its simplest form the computer 1610 can include one or more processors 1620 coupled to memory 1630 that execute various computer executable actions, instructions, and or components.

The processing unit 1620 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processing unit 1620 may also be implemented as a combination of computing devices, for example a combination of a DSP and a microprocessor, a plurality of microprocessors, multi-core processors, one or more microprocessors in conjunction with a DSP core, or any other such configuration.

The computer 1610 can include or otherwise interact with a variety of computer-readable media to facilitate control of the computer 1610 to implement one or more aspects of the claimed subject matter. The computer-readable media can be any available media that can be accessed by the computer 1610 and includes volatile and nonvolatile media and removable and non-removable media. By way of example, and not limitation, computer-readable media may comprise computer storage media and communication media.

Computer storage media includes volatile and nonvolatile, removable and non-removable media implemented in any method or technology for storage of information such as computer-readable instructions, data structures, program modules, or other data. Computer storage media includes, but is not limited to memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid state devices (e.g., solid state drive (SSD), flash memory drive (e.g., card, stick, key drive . . . ) . . . ), or any other medium which can be used to store the desired information and which can be accessed by the computer 1610.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

System memory 1630 and mass storage 1650 are examples of computer-readable storage media. Depending on the exact configuration and type of computing device, system memory 1630 may be volatile (e.g., RAM), non-volatile (e.g., ROM, flash memory . . . ) or some combination of the two. By way of example, the basic input/output system (BIOS), including basic routines to transfer information between elements within the computer 1610, such as during start-up, can be stored in nonvolatile memory, while volatile memory can act as external cache memory to facilitate processing by the processing unit 1620, among other things.

Mass storage 1650 includes removable/non-removable, volatile/non-volatile computer storage media for storage of large amounts of data relative to the system memory 1630. For example, mass storage 1650 includes, but is not limited to, one or more devices such as a magnetic or optical disk drive, floppy disk drive, flash memory, solid-state drive, or memory stick.

System memory 1630 and mass storage 1650 can include or have stored therein operating system 1660, one or more applications 1662, one or more program modules 1664, and data 1666. The operating system 1660 acts to control and allocate resources of the computer 1610. Applications 1662 include one or both of system and application software and can leverage management of resources by operating system 1660 through program modules 1664 and data 1666 stored in system memory 1630 and/or mass storage 1650 to perform one or more actions. Accordingly, applications 1662 can turn a general-purpose computer 1610 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, the workflow engine 110 can be an application 1662 or part of an application 1662 and include one or more modules 1664 and data 1666 stored in memory and/or mass storage 1450 whose functionality can be realized when executed by one or more processors or processing units 1620, as shown.

The computer 1610 also includes one or more interface components 1670 that are communicatively coupled to the bus 1640 and facilitate interaction with the computer 1610. By way of example, the interface component 1670 can be a port (e.g., serial, parallel, PCMCIA, USB, FireWire . . . ) or an interface card (e.g., sound, video . . . ) or the like. In one example implementation, the interface component 1670 can be embodied as a user input/output interface to enable a user to enter commands and information into the computer 1610 through one or more input devices (e.g., pointing device such as a mouse, trackball, stylus, touch pad, keyboard, microphone, joystick, game pad, satellite dish, scanner, camera, other computer . . . ). In another example implementation, the interface component 1670 can be embodied as an output peripheral interface to supply output to displays (e.g., CRT, LCD, plasma . . . ), speakers, printers, and/or other computers, among other things. Still further yet, the interface component 1670 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

What is claimed is:

1. A workflow system, comprising:
a processor coupled to a memory, the processor configured to execute the following computer-executable components stored in the memory:
a first component configured to receive a workflow comprising a set of nodes that represents one or more tasks and one or more items and explicitly expresses all task and item dependencies; and
a second component configured to determine an independent subset of the workflow as a function of the task and item dependences and initiate execution of the independent subset.

2. The system of claim 1, the second component is configured to initiate execution of two or more independent subsets of the workflow concurrently.

3. The system of claim 1, the second component is configured to determine the independent subset comprises a changed item and one or more tasks and/or items that depend on the changed item.

4. The system of claim 3, further comprising a third component configured to detect an item change as a function of prior state and a change definition.

5. The system of claim 4, the change definition is time independent.

6. The system of claim 4, the change definition defines an item change with respect to a dependent task.

7. The system of claim 1, further comprising a third component configured to log messages regarding workflow execution with information describing message types.

8. The system of claim 1, the workflow is produced from a description of the workflow specified in a general-purpose programming language.

9. The system of claim 1, at least one of the items is a workflow.

10. A method of workflow processing, comprising:
employing at least one processor configured to execute computer-executable instructions stored in memory to perform the following acts:
acquiring a workflow comprising a set of nodes that represents one or more tasks and one or more items, and explicitly expresses all task and item dependencies;
identifying an independent subset of the workflow as a function of the task and item dependencies; and
initiating execution of the independent subset of the workflow.

11. The method of claim 10, further comprising identifying and initiating concurrent execution of two or more independent subsets.

12. The method of claim 10, further comprising identifying a changed item in the independent subset of the workflow and one or more tasks and/or items that depend on the changed item.

13. The method of claim 12, further comprising determining whether an item has changed independent of a time stamp related to the item.

14. The method of claim 10, further comprising identify the independent subset of the workflow as a function of a task that is added or removed from the workflow and dependent tasks and/or items.

15. The method of claim 10, further comprising initiating execution of an undo command to remove results of related a task that no longer forms part of the workflow.

16. The method of claim 10, further comprising logging messages concerning workflow execution with information describing message types.

17. A workflow method, comprising:
employing at least one processor configured to execute computer-executable instructions stored in memory to perform the following acts:
receiving a program that describes a workflow in a general-purpose programming language; and
executing the program to produce a representation of the workflow comprising a set of one or more tasks and items.

18. The method of claim 17, further comprising at least one of observing, reasoning about, or modifying the representation of the workflow programmatically.

19. The method of claim 17, initiating execution of at least one of a debugger, type checker, or code optimizer tool associated with the general purpose-programming language over the program that describes the workflow.

20. The method of claim 17, further comprising providing the representation of the workflow to a workflow engine configured to utilize task and item dependencies expressed by the representation of the workflow to initiate execution of an independent subset of the workflow.
